(19) United States
(12) Patent Application Publication
(10) Pub. No.: US 2012/0297158 A1
(43) Pub. Date: Nov. 22, 2012

(54) MASS STORAGE DEVICE CAPABLE OF ACCESSING A NETWORK STORAGE

(76) Inventors: Chih-Yao Hua, New Taipei City (TW); Chun-Yu Hsieh, New Taipei City (TW); Wen-Jeng Fang, Taipei City (TW)

(21) Appl. No.: 13/110,918

(22) Filed: May 19, 2011

(51) Int. Cl. G06F 12/00; G06F 12/14

(52) U.S. Cl. 711/164; 711/154; 711/E12.093

(57) ABSTRACT

A mass storage device capable of accessing a network storage in response to an access request of an electronic device electrically connected to the mass storage device, the mass storage device includes a first memory unit comprising a file management table for storing a first mapping relationship between a logical address and a network address of the network storage, and a controller for receiving an access request corresponding to the logical address from the electronic device and accessing a file in the network storage according to the network address through a network interface.

### BACKGROUND

1. Technical Field

The present invention relates to a mass storage device, and more particularly, to a mass storage device capable of accessing a network storage.

2. Description of the Conventional Art

As related technology keeps improving, mass storage devices such as hard drives or memory cards possess more memory space for storing more data. Generally, a mass storage device comprises a file allocation table (FAT) to indicate a link between a logical address and a physical address of a file stored in the mass storage device. Please refer to FIG. 1, which is a diagram showing a structure of a conventional file allocation table. As shown in FIG. 1, the conventional file allocation table provides a mapping relationship between a logical address (for example, 47h) of a system file structure and a physical address (for example, 47h) of a file stored in the mass storage device. The logical address is an address accessible by an operating system of an electronic device. The physical address is a real address of the file stored in the mass storage device. When the electronic device tries to store to or read a file from the mass storage device, the electronic device must communicate with the mass storage device through the file allocation table.

However, traditional mass storage device such as a hard drive or a flash memory still has limited memory space. Since there are more videos and pictures taken in high resolution, the memory space of the mass storage device is getting bigger to meet the requirement. However, if the memory space is inadequate, a traditional mass storage device cannot adjust its own memory space. Therefore, the user needs to buy another new mass storage device with larger memory space, and the old mass storage device is no longer useful then. Such situation brings extra cost for the user, and is not eco-friendly.

### SUMMARY

A mass storage device capable of accessing a network storage in response to an access request of an electronic device electrically connected to the mass storage device, the mass storage device comprises a first memory unit comprising a file management table for storing a first mapping relationship between a logical address and a network address of the network storage, and a controller for receiving an access request corresponding to the logical address from the electronic device and accessing a file in the network storage according to the network address through a network interface.

A method for accessing a network storage through amass storage device is disclosed, the method comprises coupling a mass storage device to an electronic device; coupling the mass storage device to a network storage through a network interface; the electronic device accessing a file according to a logical address stored in a file management table of the mass storage device; and the mass storage device accessing the file in the network storage according to a network address stored in the file management table corresponding to the logical address.

In addition, a method for managing an account of a network storage through a mass storage device is also disclosed, which comprises coupling a mass storage device to an electronic device; coupling the mass storage device to a network storage through a network interface; the electronic device executing an application program; the application program managing an account in the network storage; and the mass storage device reading account information of the managed account in the network storage, and updating the account information in a file management table stored in the mass storage device correspondingly.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram showing a structure of a conventional file allocation table.

FIG. 2 is a diagram showing amass storage device of the present embodiment.

FIG. 3 is a diagram showing the mass storage device of FIG. 1 accessing a network storage.

FIG. 4 is a diagram showing a structure of a file management table of the present embodiment.

FIG. 5 is a flowchart of the method of the present embodiment for accessing the network storage through the mass storage device.

FIG. 6 is a flowchart of the method of the present embodiment for managing the memory space of the network storage by the application program.

FIG. 7 is a diagram showing another mass storage device of the present embodiment.

### DETAILED DESCRIPTION

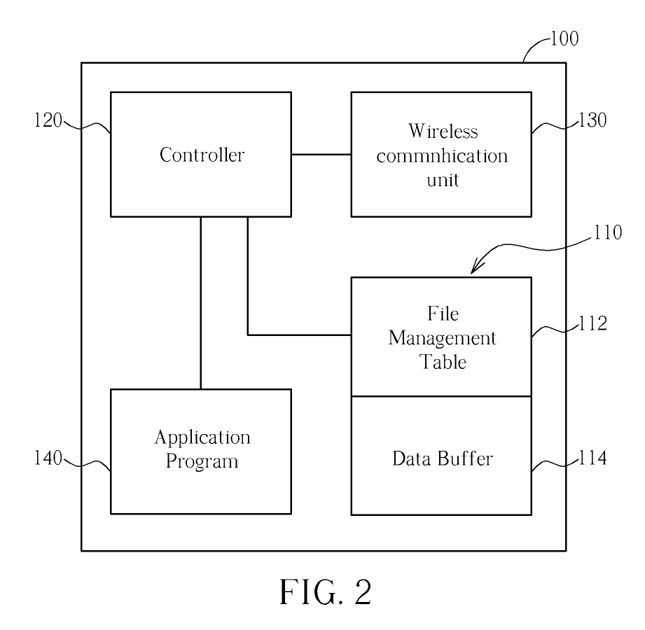

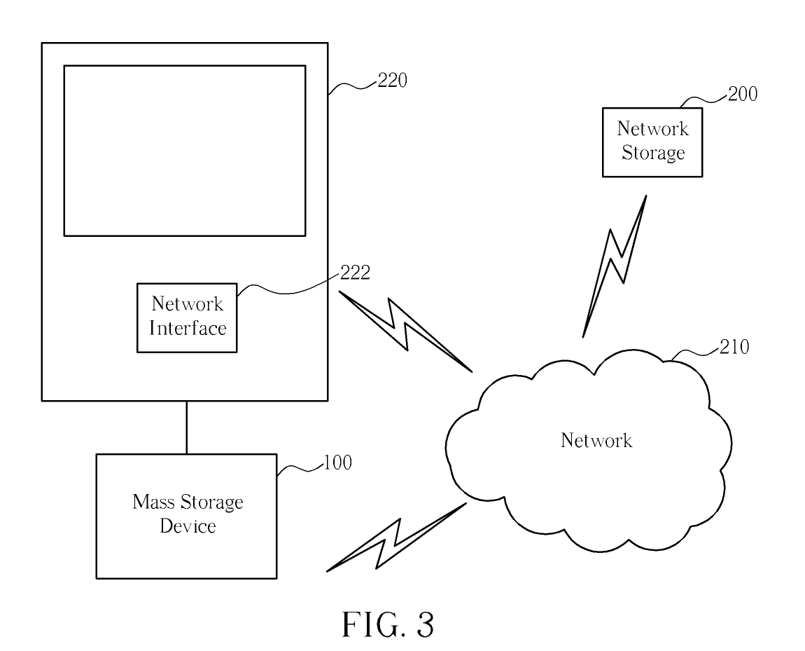

Please refer to FIG. 2 and FIG. 3. FIG. 2 is a diagram showing amass storage device 100 of the present embodiment. FIG. 3 is a diagram showing the mass storage device 100 of FIG. 2 accessing a network storage 200. The mass storage device 100 is coupled to an electronic device 220. The mass storage device 100 comprises a memory unit 110, a controller 120, and a wireless communication unit 130. The memory unit 110 can be any type of memory including magnetic memory such as hard disk, optical memory such as a rewritable optical disc, or solid state memory such as Read-only memory (ROM), NOR flash memory, NAND flash memory, or any combination of the above. The memory unit 110 comprises a space for storing a file management table 112. The file management table 112 stores storage information (total storage volume, used volume and available volume, etc.) and at least a mapping relationship between a logical address of the system file structure and a network address of the network storage 200. The logical address is an address accessible by an operating system of the electronic device 220. The network address is an assigned address of a storage unit for storing files and directories in the network storage 200. The wireless communication unit 130 is for coupling the controller 120 to the network storage 200 via a network 210 according to any wireless communication technology, for example Wi-Fi (IEEE 802.11 family), WiMAX (IEEE 802.16 family), Bluetooth, Near Field Communication (NFC), 3rd Generation Communication (3G) and its successor such as 3GPP Long Term Evolution (LTE), etc. The network could be any wired or wireless computer network including but not limited to local area network (LAN), wide area network (WAN), metropolitan area network (MAN), personal area network (PAN), virtual private network (VPN), campus area network (CAN), or storage area network (SAN).

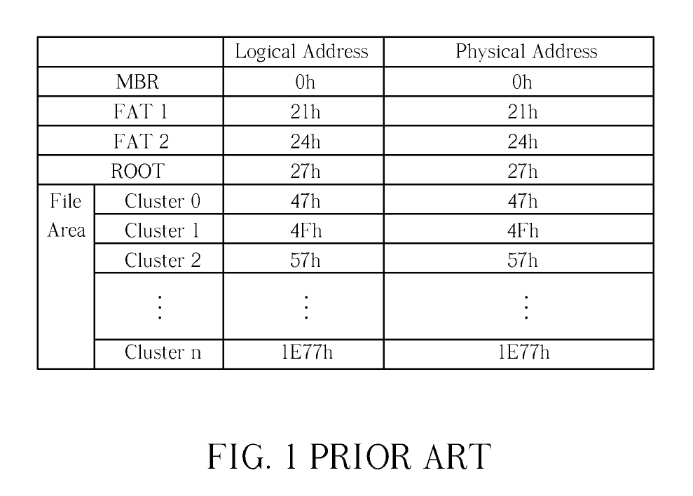

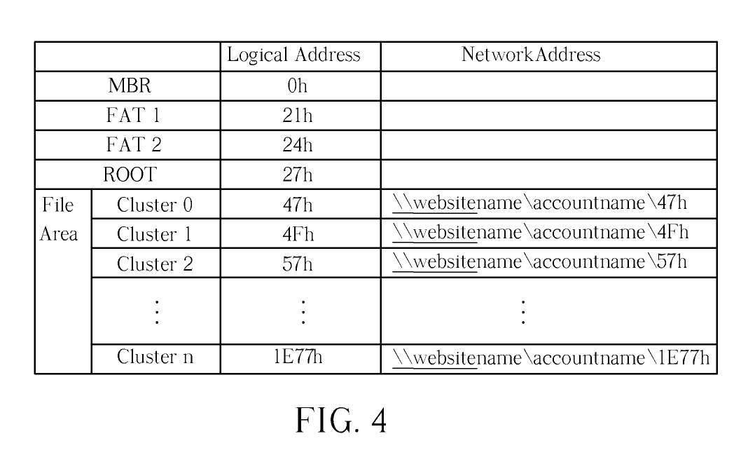

Please refer to FIG. 4, which is a diagram showing a structure of a file management table of the present embodiment. Different from the conventional file allocation table of FIG. 1, the file management table of the present embodiment provides a mapping relationship between a logical address (for example, 47h) of the system file structure and a network address (for example, \\websitename\accountname\47h) of the network storage 200. The logical addresses and the network addresses shown in FIG. 4 have corresponding names and are arranged in order. But in other embodiments, the logical addresses and the network addresses need not have corresponding names and not be in the exact order. The network address can be any type of address in the computer network according to any protocol, for example Internet Protocol (IP) such as version 4 (IPV4) or version 6 (IPV6), Unique Resource Locator (URL), Domain Name System (DNS), Hypertext Transfer Protocol (HTTP), File Transfer Protocol (FTP), Server Message Block (SMB), Web-based Distributed Authoring and Versioning (WebDAV), etc. The format of the network address shown in FIG. 4 is an example of the present embodiment, and the network address can be in another format, such as http://websitename/accountname/xxx, ftp://IPnumber/uniqedeviceID/yyy, etc. When the controller 120 is coupled to the network storage 200, the controller 120 can access a file from the network storage 200 according to the mapping relationship provided by the file management table 112. After receiving an access request of the file from the controller 120 via the network 210, the network storage 200 accesses the file stored in a memory unit of the network storage 200 according to its own file management structure.

Accessing the file comprises but is not limited to reading, writing, deleting, restoring, modifying, copying, synchronizing, compressing/uncompressing, sharing, converting, uploading, and/or downloading the file, etc.

The network storage 200 provides memory space for storing and sharing files online. According to the above arrangement, the mass storage device 100 of the present embodiment can adjust the memory space by mapping a virtual memory space of the mass storage device to the network storage 200. Therefore, the memory space of the mass storage device 100 becomes virtually unlimited.

The network storage can be any type of remote or local network storage, such as Network Attached Storage (NAS), file server, FTP server, or HTTP server. The network storage can also be a cloud storage service, such as Dropbox, Amazon S3, etc.

The mass storage device 100 can further comprise an application program 140 for accessing the network storage 200 and managing an account in the network storage 200. For example, the electronic device 220 can perform the application program 140 to create an account at the network storage 200 and set up a password for verification. The electronic device 220 can further utilize the application program 140 to login to and/or logout from the network storage 200. The login process comprises inputting an account name and a corresponding password to the network storage 200 and/or checking a unique device ID of the mass storage device 100. The unique device ID of the mass storage device 100 is a unique serial number, therefore, the mass storage device 100 can act as a key to access the network storage 200. The application program 140 can also be utilized to manage an account in the network storage 200. Managing the account comprises but is not limited to, increasing or decreasing the memory space of the account, enabling, disabling or deleting an account, managing files in the memory space, and/or obtaining a public network address to share files with others. The application program 140 can further update the total memory space, which reflects the memory space in the network storage 200, of the mass storage device 100. Therefore, the memory space provided in the network storage 200 becomes a part of the memory space of the mass storage device 100. The application program 140 can be stored in the memory unit 110 of the mass storage device 100, or in another memory unit of the mass storage device 100. The application program 140 can even be stored in a remote storage, and be executed through a hyperlink or a web address.

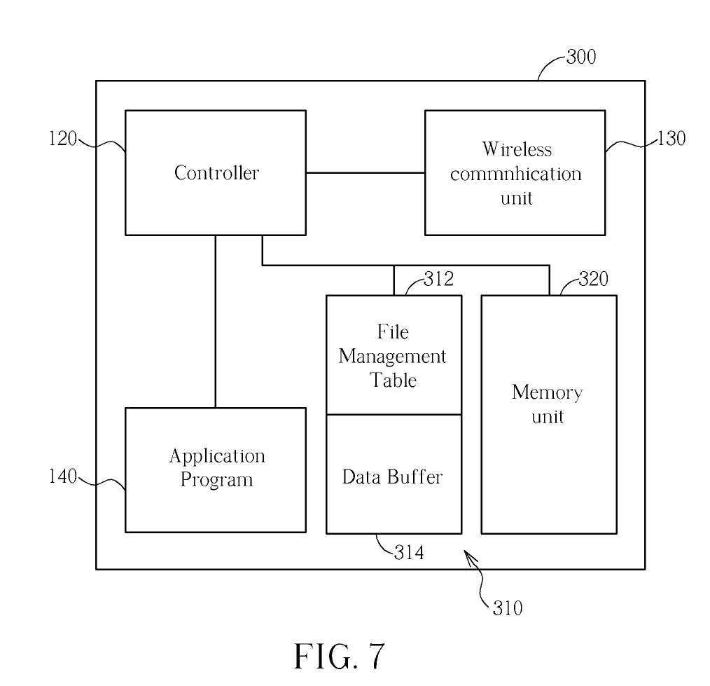

As shown in FIG. 7, the mass storage device 300 can further comprise another memory unit 320 for providing physical memory space to the user. When the mass storage device 300 is electrically connected to the electronic device, the user can select the network storage 200 or the physical memory space of the memory unit 320 to access data. The file management table 312 can further comprise a mapping relationship between a logical address and a physical address of the second memory unit.

In addition, although the mass storage device 100 described above is independent from the electronic device 220, the mass storage device 100 can also be embedded in the electronic device 200. The mass storage device 100 can be a hard drive, a memory card or a USB drive.

A part of the memory unit 110 can be optionally utilized as a data buffer 114. The data buffer 114 is for buffering the file when the controller 120 transmits/receives the file to/from the network storage 200 with limited data transmitting speed. The data buffer 114 can also temporarily store the file when the network 210 is not available, and the file can be transmitted to the network storage 200 later when the network 210 is available again. When data transmitting speed is fast enough, the data buffer may not be necessary. In addition, if the memory space of the memory unit 110 is large enough, another part of the memory unit 110 can be utilized as a physical memory. In this case, the memory unit 110 can be divided into two independent portions, a portion for network storage and a portion for physical memory.

In addition, when an alternate connection to the network 210 is used, the wireless communication unit also may not be necessary. For example, if the electronic device 220 is already connected to the network 210 via a network interface 222, the controller 120 can directly access the network storage 200 via the network interface 222 of the electronic device 220.

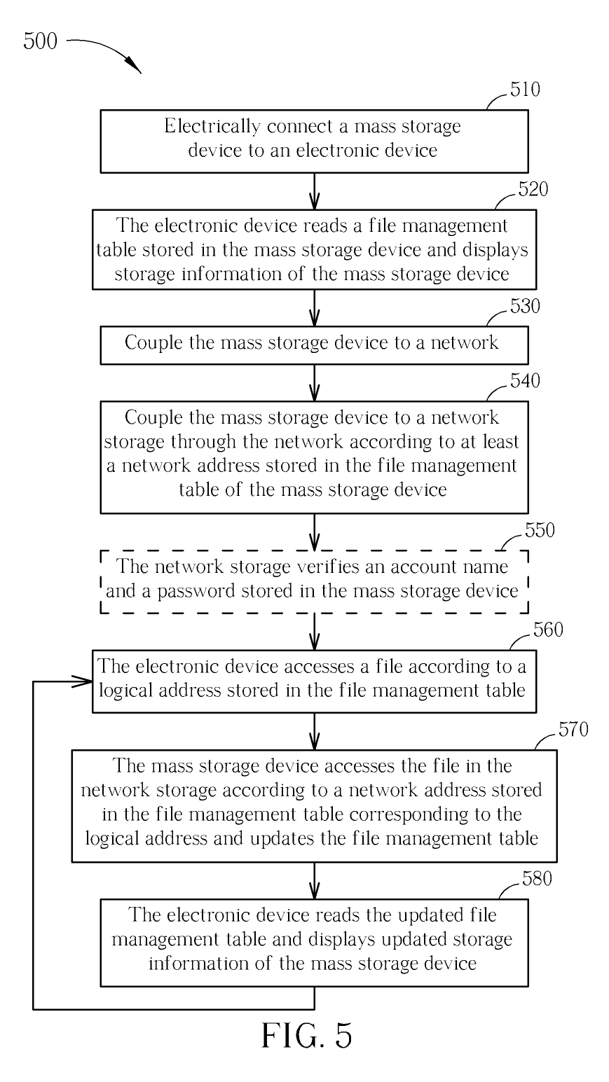

Please refer to FIG. 5, which is a flowchart 500 of the method of the present embodiment for accessing the network storage through the mass storage device. The flowchart 500 comprises the following steps:

Step 510: Electrically connect a mass storage device to an electronic device;

Step 520: The electronic device reads a file management table stored in the mass storage device and displays storage information of the mass storage device;

Step 530: Couple the mass storage device to a network through either a wireless communication unit of the mass storage device or a network interface of the electronic device;

Step 540: Couple the mass storage device to a network storage through the network according to at least a network address stored in the file management table of the mass storage device;

Step 550: The network storage verifies an account name and a password stored in the mass storage device;

Step 560: The electronic device accesses a file according to a logical address stored in the file management table;

Step 570: The mass storage device accesses the file in the network storage according to a network address stored in the file management table corresponding to the logical address and updates the file management table; and

Step 580: The electronic device reads the updated file management table and displays updated storage information of the mass storage device.

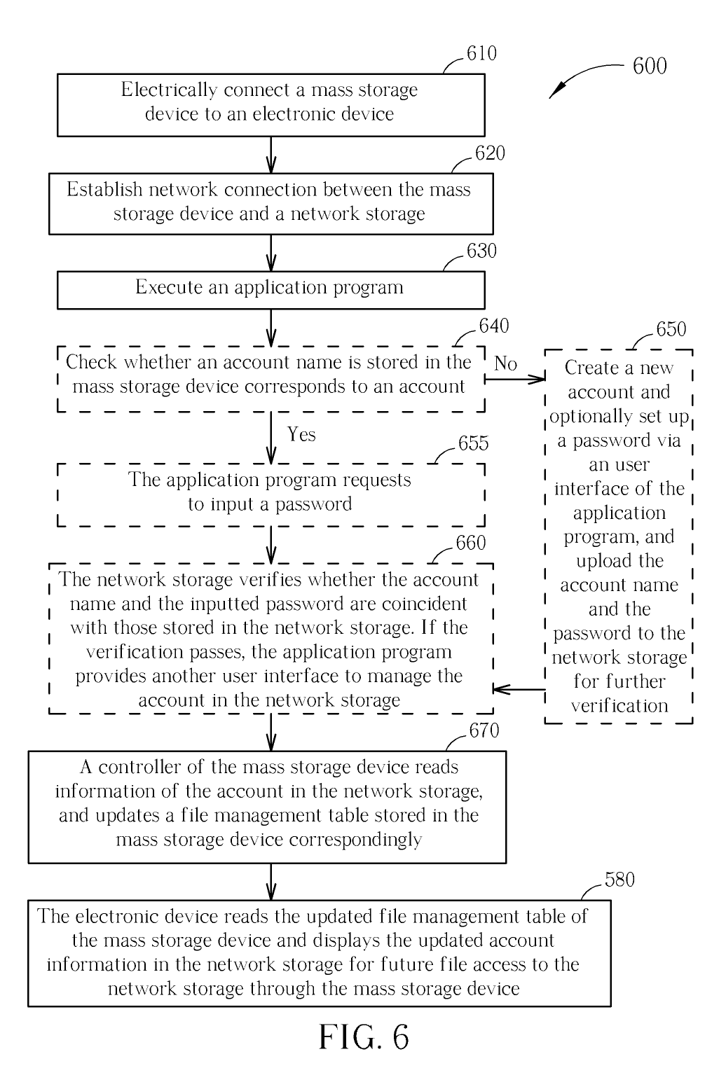

Please refer to FIG. 6, which is a flowchart 600 of the method of the present embodiment for managing an account of the network storage by the application program. The flowchart 600 comprises the following steps:

Step 610: Electrically connect a mass storage device to an electronic device;

Step 620: Establish network connection between the mass storage device and a network storage through either a wireless communication unit of the mass storage device or a network interface of the electronic device;

Step 630: Execute an application program;

Step 640: Check whether an account name is stored in the mass storage device corresponds to an account; (No) Step 650: Create a new account and optionally set up a password via an user interface of the application program, and upload the account name and the password to the network storage for further verification;

Step 655: The application program requests to input a password; (Yes) Step 660: The network storage verifies whether the account name and the inputted password are coincident with those stored in the network storage. If the verification passes, the application program provides another user interface to manage the account in the network storage;

Step 670: A controller of the mass storage device reads information of the account in the network storage, and updates a file management table stored in the mass storage device correspondingly; and

Step 680: The electronic device reads the updated file management table of the mass storage device and displays the updated account information in the network storage for future file access to the network storage through the mass storage device.

Basically, to achieve the same result, the steps of the flowcharts 500 and 600 need not be in the exact order shown and need not be contiguous, that is, other steps can be inserted therebetween, such as making a payment for buying extra memory space in order to increase the memory space of the account in the network storage. The step 550 and the step 640 to 660 are optional. The network storage can verify the unique device ID of the mass storage device instead. The unique device ID can be integrated into the network address, for example, the network address can be expressed as \\websitename\uniquedevicelD\47h.

In addition, the storage information of step 520, 580 and the account information of step 680 comprises information of total storage volume, volume usage status, and available volume, etc., and the electronic device reading the storage information can display those information in a file manager application such as Windows® Explorer and Mac® OS X Finder, such that the mass storage device of the present embodiment behaves like a general mass storage device with physical memory space.

In contrast to the prior art, the present embodiment provides a mass storage device capable of accessing a network storage. The mass storage device of the present embodiment can further adjust the total memory space by coupling to the network storage. Therefore, the memory space of the mass storage device has no limitation.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A mass storage device capable of accessing a network storage in response to an access request of an electronic device electrically connected to the mass storage device, the mass storage device comprising:
a first memory unit comprising a file management table for storing a first mapping relationship between a logical address and a network address of the network storage; and
a controller for receiving an access request corresponding to the logical address from the electronic device and accessing a file in the network storage according to the network address through a network interface.

2. The mass storage device of claim 1 further comprising a wireless communication unit for providing the network interface.

3. The mass storage device of claim 1, wherein the network interface is a network interface of the electronic device.

4. The mass storage device of claim 1, wherein the first memory unit further comprises a data buffer for buffering the file.

5. The mass storage device of claim 1 further comprising a second memory unit, wherein the file management table further comprises a second mapping relationship between a logical address and a physical address of the second memory unit.

6. The method of claim 5, wherein the network address comprises information corresponding to an account name of the network storage and/or a unique device ID of the mass storage device.

7. A method for accessing a network storage through a mass storage device, comprising:
coupling a mass storage device to an electronic device;
coupling the mass storage device to a network storage through a network interface;
the electronic device accessing a file according to a logical address stored in a file management table of the mass storage device; and
the mass storage device accessing the file in the network storage according to a network address stored in the file management table corresponding to the logical address.

8. The method of claim 7 further comprising the network storage verifying an account name and a password stored in the mass storage device.

9. The method of claim 7 further comprising the network storage verifying a unique device ID of the mass storage device.

10. The method of claim 7 further comprising the mass storage device updating the file management table after the file being accessed.

11. The method of claim 10 further comprising the electronic device displaying storage information of the mass storage device according to the updated file management table.

12. The method of claim 7, wherein the network interface is a wireless communication unit of the mass storage device or a network interface of the electronic device.

13. The method of claim 7, wherein the network address comprises information corresponding to an account name of the network storage and/or a unique device ID of the mass storage device.

14. A method for managing an account of a network storage through a mass storage device, comprising:
coupling a mass storage device to an electronic device;
coupling the mass storage device to a network storage through a network interface;
the electronic device executing an application program;
the application program managing an account in the network storage; and
the mass storage device reading account information of the managed account in the network storage, and updating the account information in a file management table stored in the mass storage device correspondingly.

15. The method of claim 14 further comprising the electronic device displaying the updated memory space information.

16. The method of claim 14 further comprising the network storage verifying an account name and a password stored in the mass storage device.

17. The method of claim 14 wherein the application program managing the account in the network storage comprises the application program managing a memory space of the account in the network storage.

18. The method of claim 14 further comprising the network storage verifying a unique device ID of the mass storage device.

19. The method of claim 14, wherein the network interface is a wireless communication unit of the mass storage device or a network interface of the electronic device.

20. The method of claim 14, wherein the network address comprises information corresponding to an account name of the network storage and/or a unique device ID of the mass storage device.
